(19) United States
(12) Patent Application Publication
(10) Pub. No.: US 2024/0255897 A1
(43) Pub. Date: Aug. 1, 2024

(54) WRIST-WORN APPARATUS

(71) Applicant: GOERTEK INC., Weifang, Shandong (CN)

(72) Inventors: Fanli BU, Weifang, Shandong (CN); Xue YANG, Weifang, Shandong (CN)

(21) Appl. No.: 18/564,636

(22) PCT Filed: Nov. 1, 2021
(86) PCT No.: PCT/CN2021/127873

§ 371 Date: Nov. 28, 2023

(30) Foreign Application Priority Data
Jun. 22, 2021 (CN) 202110695736.5

(51) Int. Cl. G04B 19/28; G04G 17/04; G04G 21/02

(52) U.S. Cl. CPC G04B 19/283; G04G 17/045; G04G 21/025

(57) ABSTRACT

Disclosed in the present disclosure is a wrist-worn apparatus. The wrist-worn apparatus includes a middle bezel, a display module and a plurality of functional modules, wherein the display module is mounted to the middle bezel, a display area of the display module is located at an inner side of the middle bezel, the plurality of functional modules are mounted on the middle bezel, and each of the functional modules is at least partially located on an outer peripheral side of the display area. According to the technical solution of the present disclosure, the occupancy of a mounting space of the display module by the functional modules can be reduced.

The present disclosure claims the priority to the Chinese Patent Application No. 202110695736.5, entitled “WRIST-WORN APPARATUS” filed with China Patent Office on Jun. 22, 2021, the entire contents of which are incorporated into the present disclosure by reference.

### TECHNICAL FIELD

The present disclosure relates to a technical field of wearable electronic devices, and more particularly, to a wrist-worn apparatus.

### DESCRIPTION OF RELATED ART

With the continuous development and popularization of wrist-worn apparatus, their functions are gradually increasing. For example, in some wrist-worn apparatus with call functions, functional modules such as loudspeakers and microphones need to be provided; when video call function is needed, cameras also need to be added; and if other functions are needed, corresponding function modules also need to be added. However, as the number of functional modules increases, each functional module may occupy the screen mounting space while maintaining the overall size of the apparatus unchanged, causing screen deformation, which is very inconvenient for human-computer interaction and seriously reduces user experience.

### SUMMARY

A main object of the present disclosure is to provide a wrist-worn apparatus, aiming at reducing the occupancy of a mounting space of a display module by functional modules.

In order to achieve the above purpose, the present disclosure provides a wrist-worn apparatus, including:
a middle bezel;
a display module mounted to the middle bezel, a display area of the display module is located at an inner side of the middle bezel; and
a plurality of functional modules mounted on the middle bezel, and each of the functional modules is at least partially located on an outer peripheral side of the display area.

Optionally, the middle bezel includes two opposite first bezel walls and two opposite second bezel walls, the first bezel walls and the second bezel walls are alternately distributed in sequence in a circumferential direction of the middle bezel, and each of the two first bezel walls is provided with a wristband connecting portion;

the plurality of functional modules comprise a camera module and a loudspeaker module, the loudspeaker module is provided on one of the second bezel walls, and the camera module is provided on the other of the second bezel walls.

Optionally, an accommodating groove is provided on an inner side surface of a second bezel wall where the camera module is located, a pressure relief hole is provided on a bottom wall of the accommodating groove, a venting waterproof component is provided in the accommodating groove, wherein the venting waterproof component is configured to cover the pressure relief hole, and the pressure relief hole is communicated with a rear sound cavity of the loudspeaker module through the venting waterproof component; and/or,

the second bezel wall is provided with a receiving groove and a sound outlet hole that penetrates through the receiving groove, the loudspeaker module is at least partially disposed in the receiving groove, and a sound outlet side of the loudspeaker module is configured to face the sound outlet hole.

Optionally, the second bezel wall is provided with a mounting portion, the mounting portion is configured to protrude toward an outer peripheral surface of the second bezel wall, and the camera module is mounted to the mounting portion.

Optionally, the mounting portion is provided with a first mounting groove, the first mounting groove extends toward an inner side of the second bezel wall and penetrates through an inner side surface of the second bezel wall, and the camera module is disposed in the first mounting groove; and/or,

the mounting portion is provided on the second bezel wall on a three o'clock orientation side of the middle bezel; and/or,

an operation key is provided on an outer side surface of a second bezel wall where the mounting portion is located, and the operation key is disposed adjacent to the mounting portion; the number of the operation key is two, and the two operation keys are disposed on two opposite sides of the mounting portion respectively.

Optionally, the plurality of the functional modules further include a physiological signal detection module therein, the physiological signal detection module is provided with a finger pressure detection electrode, and the finger pressure detection electrode is disposed to the mounting portion.

Optionally, the mounting portion is made of conductive material, the mounting portion is electrically connected to the physiological signal detection module, so that the mounting portion serves as the finger pressure detection electrode, and a press detection area is provided on a surface of the mounting portion away from the display module; or,

the mounting portion is made of insulating material, and the finger pressure detection electrode is embedded in the mounting portion and exposed on the surface of the mounting portion away from the display module.

Optionally, the wrist-worn apparatus further includes a back cover connected to the middle bezel, and the physiological signal detection module is further provided with at least one wearing detection electrode, the wearing detection electrode is disposed on the back cover.

Optionally, the middle bezel is made of conductive material, the wrist-worn apparatus further includes a circuit board provided in the middle bezel and a mobile communication module provided on the circuit board, the mobile communication module is provided with a feed terminal and a ground terminal, both of the feed terminal and the ground terminal are disposed on a side of the circuit board away from the camera module and are electrically connected to the middle bezel so that the middle bezel serves as an antenna carrier of the mobile communication module.

Optionally, both of the feed terminal and the ground terminal are electrically connected to a second bezel wall where the loudspeaker module is located, and the feed terminal and the ground terminal are disposed on two opposite sides of the loudspeaker module respectively; and/or,
the ground terminal is detachably connected to the middle bezel, and elastically abuts the circuit board.

Optionally, the wrist-worn apparatus includes a battery module, an antenna clearance area is provided between an inner side of the second bezel wall where the loudspeaker module is located and the battery module, and at least one end portion of the antenna clearance area extends to between the inner side of the first bezel wall and the battery module.

Optionally, the wrist-worn apparatus further includes a charging module electrically connected to the battery module, the antenna clearance area extending to between the inner side of the first bezel wall and the battery module and the charging module are disposed on two opposite sides of the battery module respectively.

Optionally, a second mounting groove is provided on an inner side surface of the first bezel wall, the wristband connecting portion is provided with a sound inlet hole, and the sound inlet hole is communicated with the second mounting groove; one of the plurality of functional modules is a microphone module, the microphone module is disposed in the second mounting groove, and a sound receiving end portion of the microphone module is disposed to face the sound inlet hole.

Optionally, the wrist-worn apparatus further includes a back cover and a WI-FI module, the back cover is connected to the middle bezel, the WI-FI module is provided with a first antenna, and the first antenna is provided on an inner surface of the back cover.

Optionally, the battery module of the wrist-worn apparatus is disposed in the middle bezel and spaced apart from an inner side surface of the middle bezel, and the first antenna is at least partially disposed between the inner side surface of the middle bezel and the battery module; and/or,
the first antenna has a ring shape and extends in a circumferential direction of the middle bezel; and/or,
the back cover includes an annular connecting portion and a cover plate portion located inside the annular connecting portion, the annular connecting portion is connected to the middle bezel, the cover plate portion is configured to protrude towards a direction away from the display module in comparison to the annular connecting portion, and the first antenna is provided on an inner surface of the annular connecting portion.

Optionally, the wrist-worn apparatus further includes a positioning module, the positioning module is provided with a second antenna, and the second antenna is disposed on a rear surface of the display module.

Optionally, the second antenna has a sheet shape and is laid on the rear surface of the display module.

Optionally, the wrist-worn apparatus comprises a circuit board and a battery module electrically connected to the circuit board, the circuit board is disposed between the display module and the battery module; a surface of the circuit board facing the battery module and a surface of the circuit board facing the display module are both electronic device mounting surfaces.

Optionally, the wrist-worn apparatus further includes a wristband and a connecting member, the wristband connecting portion of the middle bezel is provided with a second mounting groove, and the connecting member has a buckle portion disposed in the first mounting groove and a driving portion exposed to outside the first mounting groove, the connecting member is movably pivoted to the first mounting groove, so that the buckle portion has a first position and a second position; driving of the driving portion enables the buckle portion to move between the first position and the second position; an end portion of the wristband is provided with a plug-in portion, and the plug-in portion is detachably connected to the second mounting groove and is provided with a slot engaged with the buckle portion; at the first position, the buckle portion is engaged with the slot to lock the wristband; at the second position, the buckle portion is disengaged from the slot to unlock the wristband.

Optionally, the wrist-worn apparatus includes a wristband, a magnetic field sensor and a controller, the wristband is detachably connected to the wristband connecting portion, the wristband is provided with a magnet; the magnetic field sensor is disposed in the middle bezel, the magnetic field sensor is used to sense magnetic field parameters of the magnet and generate a corresponding screen display control signal; the controller is disposed in the middle bezel, and the controller can control the display module to display a corresponding display mode according to the screen display control signal.

According to the technical solution of the present disclosure, a display area of the display module is provided at an inner side of the middle bezel, the plurality of functional modules are mounted on the middle bezel, and each of the functional modules is at least partially located on an outer peripheral side of the display area. By disposing the functional modules using the middle bezel, the space occupied at the inner side of the middle bezel by the functional modules can be reduced, which reduces the occupancy of a mounting space of the display module by the functional modules, so that all the area at an inner side of the middle bezel is the display area, ensuring that the wrist-worn apparatus has a large display screen and is convenient for human-computer interaction. In addition, the mounting area of modules such as battery module can be enlarged and the battery life of wrist-worn apparatus is improved.

### BRIEF DESCRIPTION OF DRAWINGS

In order to more clearly illustrate the embodiments of the present disclosure or the technical solutions in the prior art, the drawings required to be used for the content of the embodiments or the prior art will be briefly introduced in the following. Obviously, the drawings in the following description are merely some embodiments of the present disclosure, and for those of ordinary skill in the art, other drawings can also be obtained from the provided drawings without any creative effort.

FIG. 1 is a schematic structural diagram of a wrist-worn apparatus according to an embodiment of the present disclosure;

FIG. 2 is a schematic structural diagram of the wrist-worn apparatus in FIG. 1 with a display module removed;

FIG. 3 is a schematic structural diagram of a middle bezel in FIG. 2 and its internal components;

FIG. 4 is a schematic structural diagram of the middle bezel in FIG. 3;

FIG. 5 is a schematic cross-sectional view of the wrist-worn apparatus in FIG. 1;

FIG. 6 is an enlarged view of part A in FIG. 5;

FIG. 7 is an enlarged view of part B in FIG. 5;

FIG. 8 is a schematic structural diagram of the wrist-worn apparatus in FIG. 1 viewed from another angle;

FIG. 9 is a schematic structural diagram of the wrist-worn apparatus in FIG. 1 with the middle bezel and the display module removed;

FIG. 10 is a schematic structural diagram of an antenna clearance area in the wrist-worn apparatus in FIG. 1;

FIG. 11 is a schematic cross-sectional view of the wrist-worn apparatus in FIG. 1 at a microphone module;

FIG. 12 is a schematic structural diagram of a first antenna in FIG. 6;

FIG. 13 is a schematic structural diagram of the rear surface of the display module in FIG. 1;

FIG. 14 is a schematic structural diagram of a second antenna in FIG. 13;

FIG. 15 is an exploded view of the connection between the middle bezel and the wristband in FIG. 1;

FIG. 16 is a schematic cross-sectional view of the connection between the middle bezel and the wristband in FIG. 1, in which the buckle portion is in the second position;

FIG. 17 is a schematic structural diagram showing that the buckle portion in FIG. 16 is in the first position; and

FIG. 18 is a schematic structural diagram of the connecting member, elastic member and connecting shaft in FIG. 15.

Explanation of reference numerals of the embodiments are as below:

| Reference | | Reference | |
|---|---|---|---|
| Numeral | Name | Numeral | Name |
| 100 | middle bezel | 210 | display module |
| 110 | first bezel wall | 220 | camera module |
| 111 | wristband | 230 | loudspeaker |
| | connecting | | module |
| | portion | | |
| 112 | second | 231 | loudspeaker |
| | mounting | | fixing member |
| | groove | | |
| 113 | third mounting | 240 | microphone |
| | groove | | module |
| 114 | sound inlet | 250 | battery module |
| | hole | | |
| 120 | second bezel | 260 | circuit board |
| | wall | | |
| 121 | receiving | 270 | operation key |
| | groove | | |
| 122 | sound outlet hole | 280 | venting |
| | | | waterproof |
| | | | component |
| 123 | accommodating | 290 | charging |
| | groove | | module |
| 124 | pressure | 310 | feed terminal |
| | relief hole | | |
| 125 | mounting | 320 | ground |
| | portion | | terminal |
| 126 | first mounting | 330 | first antenna |
| | groove | | |
| 410 | finger | 340 | first feed |
| | pressure | | switch |
| | detection | | |
| | electrode | | |
| 420 | wearing | 350 | second antenna |
| | detection | | |
| | electrode | | |
| 500 | back cover | 360 | second feed |
| | | | switch |
| 510 | annular | 370 | antenna |
| | connecting | | clearance area |
| | portion | | |
| 520 | cover plate | 371 | first |
| | portion | | clearance area |
| 710 | connecting | 372 | second |
| | member | | clearance area |
| 711 | buckle portion | 600 | wristband |
| 712 | driving | 610 | wearing body |
| | portion | | |
| 720 | elastic member | 611 | second groove |
| 721 | spring | 620 | plug connector |
| 722 | first torsion arm | 621 | plug-in portion |
| 723 | second torsion arm | 622 | slot |
| 730 | connecting shaft | 623 | first groove |
| 800 | magnet | | |

The realization of objects, functional features and advantages of the present disclosure will be further described in conjunction with the embodiments and with reference to the accompanying drawings.

### DETAILED DESCRIPTIONS

Technical solutions of embodiments of the present disclosure will be clearly and completely described below with reference to the drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without creative efforts shall fall within the protection scope of the present disclosure.

It should be noted that all directional indications (such as up, down, left, right, front, back . . . ) in the embodiments of the present disclosure are only used to explain the relative positional relationships and movement conditions, etc. among the components in a specific posture (as shown in the accompanying drawings), and if the specific posture changes, the directional indication will also be changed accordingly.

In addition, “first”, “second”, etc. in the present disclosure are only for descriptive purposes, and should not be construed as indicating or implying their relative importance or implicitly indicating the quantity of indicated technical features. Thus, the features defined with “first”, “second”, etc. may explicitly or implicitly include at least one of these features. In addition, the meaning of “and/or” herein includes three parallel schemes. For example, the meaning of “A and/or B” includes a scheme A, a scheme B, or a scheme of both A and B. In addition, the technical solutions of various embodiments of the present disclosure can be combined with each other, but it should be based on the fact that the technical solutions can be realized by those skilled in the art. When the combination of technical solutions is contradictory or cannot be realized, it should be considered that the combination does not exist and is not within the scope of protection required by the present disclosure.

The present disclosure provides a wrist-worn apparatus, which may be a smart watch or a bracelet.

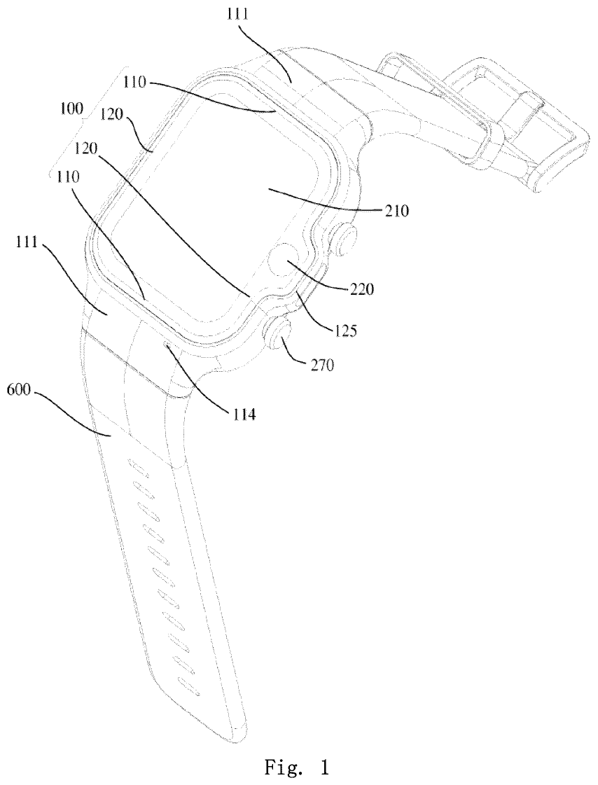

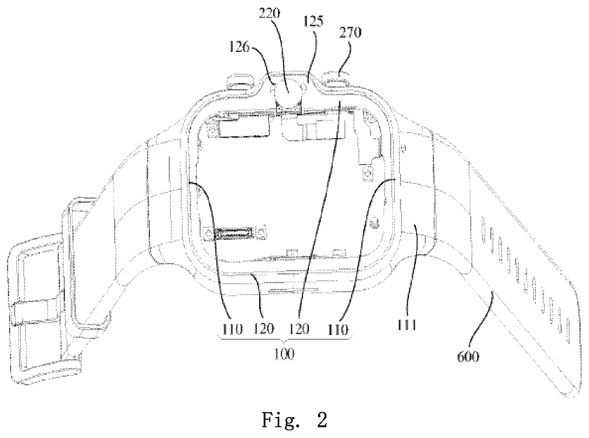

Referring to FIGS. 1-3, in an embodiment of the present disclosure, the wrist-worn apparatus includes a middle bezel 100, a display module 210 and a plurality of functional modules, the display module 210 is mounted to the middle bezel 100, a display area of the display module 210 is positioned at an inner side of the middle bezel 100, the plurality of functional modules are mounted on the middle bezel 100, and each of the functional modules is at least partially located on an outer peripheral side of the display area. That is, each of the functional modules is at least partially located on an outer peripheral side of the display area.

In the embodiment, the display module 210 includes a display screen assembly and a cover plate covering the outside of the display screen assembly, an edge of the cover plate covers an inner edge of the middle bezel 100, and the display screen assembly is located inside the mounting bezel, that is, the area where the display screen assembly is located is the display area. The display component can perform display through the cover plate, that is, the cover plate is made of transparent material. Here, the plurality of functional modules at least include one or more of a camera module 220, a loudspeaker module and a microphone module, and of course, other functional modules may also be included.

According to the technical solution of the present disclosure, the display area of the display module 210 is provided at an inner side of the middle bezel 100, the plurality of functional modules are mounted on the middle bezel 100, and each of the functional modules is at least partially located on an outer peripheral side of the display area. By disposing the functional modules by using the middle bezel 100, the space occupied at the inner side of the middle bezel 100 by the functional modules can be reduced, which reduces the occupancy of a mounting space of the display module 210 by the functional modules, so that the area at the inner side of the middle bezel 100 is all the display area, ensuring that the wrist-worn apparatus has a large the display screen and is convenient for human-computer interaction. In addition, the mounting area of modules such as battery module may be enlarged and the battery life of wrist-worn apparatus is improved.

In the embodiment, the middle bezel 100 includes two opposite first bezel walls 110 and two opposite second bezel walls 120, the first bezel walls 110 and the second bezel walls 120 are alternately distributed in sequence in a circumferential direction of the middle bezel, and each of the two first bezel walls 110 is provided with a connecting portion 111 of wristband 600. Specifically, the connecting portion 111 of wristband 600 is used for mounting the wristband 600, wherein the wristband 600 may adopt a conventional structure of the wristband 600, which is not limited here. Wherein, the first bezel walls 110 and the second bezel walls 120 may have a straight bezel structure, which means that the middle bezel 100 has a square shape; or the first bezel walls 110 and the second bezel walls 120 may have a convex arc-shaped bezel structure, in which the curvature of each first bezel wall 110 and the curvature of each second bezel wall 120 are the same (when each first bezel wall 110 and each second bezel wall 120 share the center of the circle, that is, the middle bezel 100 is circular), or the curvatures of some bezel walls of the first bezel walls 110 and the second bezel walls 120 may also be the same (for example, when the middle bezel 100 is oval, the two first bezel walls 110 have the same curvature, and the two second bezel walls 120 have the same curvature), or the curvatures of any two of the first bezel walls 110 and the second bezel walls 120 may also be different.

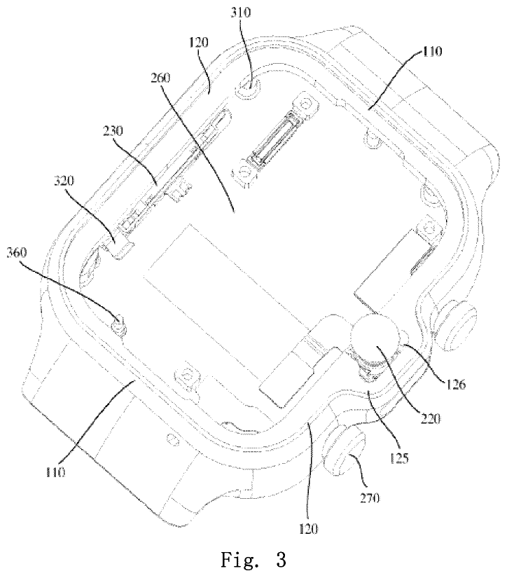

Referring to FIGS. 3-6, in an embodiment, the plurality of functional modules include a camera module 220 and a loudspeaker module 230 therein, the loudspeaker module 230 is provided on one of the second bezel walls 120, and the camera module 220 is provided on the other of the second bezel walls 120. Accordingly, the camera module 220 and the loudspeaker module 230 are disposed on two opposite sides of the display module 210 respectively, which can avoid mutual interference between the mounting of the camera module 220 and the mounting of the loudspeaker module 230, and can make full use of the space of the two second bezel walls 120 to arrange the camera module 220 and the loudspeaker module 230, thereby improving the structural compactness of the wrist-worn apparatus. Of course, in other embodiments, the loudspeaker module 230 may also be disposed on one of the first bezel walls 110 and the camera module 220 may be disposed on the other of the first bezel walls 110.

In an embodiment, the second bezel wall 120 is provided with a receiving groove 121 and a sound outlet hole 122 that penetrates the receiving groove 121, the loudspeaker module 230 is at least partially disposed in the receiving groove 121, and a sound outlet side of the loudspeaker module 230 faces the sound outlet hole 122. Accordingly, the space occupied by the loudspeaker module 230 in the middle bezel 100 can be reduced, so that the middle bezel 100 have a larger space for mounting modules such as the battery module 250, thereby being beneficial to improving the battery life of the wrist-worn apparatus. Of course, in other embodiments, a groove may also be provided on a side of the second bezel wall 120 located on the rear surface of the wrist-worn apparatus, and the loudspeaker module 230 may be disposed in the groove.

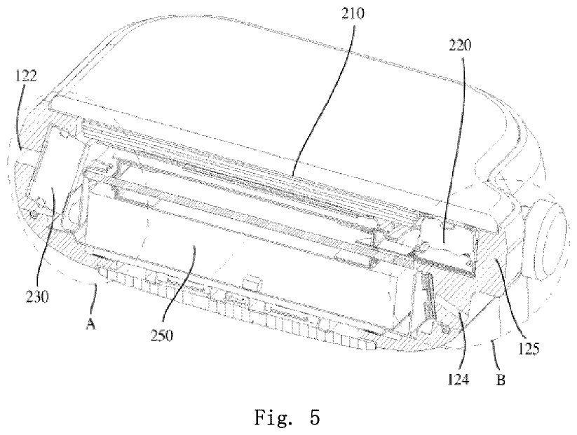

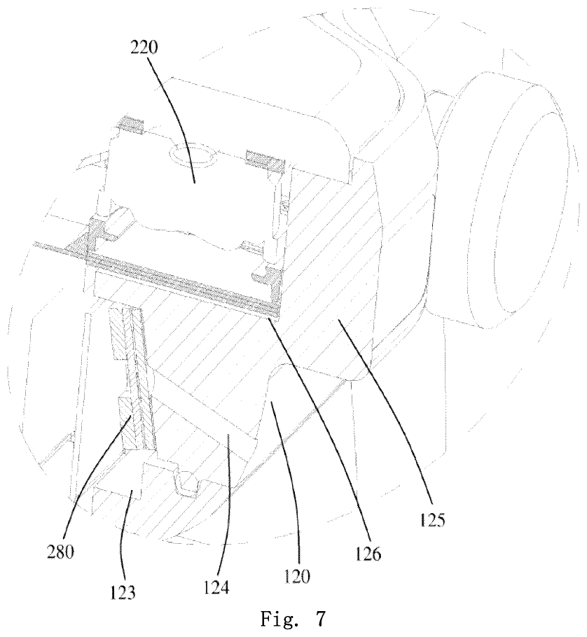

Referring to FIGS. 5 and 7, in an embodiment, an accommodating groove 123 is provided on an inner side surface of the second bezel wall 120 where the camera module 220 is located, a pressure relief hole 124 is provided on a bottom wall of the accommodating groove 123, and a venting waterproof component 280 is provided in the accommodating groove 123, the venting waterproof component 280 is disposed to cover the pressure relief hole 124, and the pressure relief hole 124 is communicated with a rear sound cavity of the loudspeaker module 230 through the venting waterproof component 280. Specifically, the venting waterproof component 280 is used to prevent liquids such as water from entering the rear sound cavity of the loudspeaker module 230, and is used to improve the waterproof performance of the wrist-worn apparatus. Since the camera module 220 is smaller in size compared to the loudspeaker module 230, the space of the second bezel wall 120 where the mounting portion 125 is located can be fully utilized to dispose the venting waterproof component 280, by disposing the pressure relief hole 124 in the second bezel wall 120 where the mounting portion 125 is located, thereby improving the structural compactness of the wrist-worn apparatus. In addition, by providing the accommodating groove 123 at the inner side surface of the second bezel wall 120 and disposing the venting waterproof component 280 in the accommodating groove 123, it can prevent the venting waterproof component 280 from protruding from an inner peripheral surface of the middle bezel 100 and occupying the mounting space of the battery module 250 or other modules. Here, the pressure relief hole 124 and the rear sound cavity of the loudspeaker module 230 may be communicated with each other through a conduit, or a pressure relief channel may be formed in the middle bezel 100, so that the pressure relief hole 124 and the rear sound cavity of the loudspeaker module 230 can be communicated with each other through the pressure relief channel. Of course, in other embodiments, the pressure relief hole 124 and the venting waterproof component 280 may also be provided in the first bezel wall 110.

Referring to FIGS. 1-4 and 7, in an embodiment, the second bezel wall 120 is provided with a mounting portion 125, the mounting portion 125 is configured to protrude toward an outer peripheral surface of the second bezel wall 120, and the camera module 220 is mounted on the mounting portion 125. By configuring the mounting portion 125 to protrude toward the outer peripheral surface of the middle bezel 100, it is equivalent to moving the installation position of the camera module 220 outward when mounting the camera module 220 on the mounting portion 125, thereby reducing or even avoiding the occupation of the inner space of the middle bezel 100 by the camera module 220. That is, it is possible to reduce or even avoid the occupation of the mounting area of the display module 210 and other modules (such as the battery module 250) by the camera module 220, and avoid the camera module 220 from occupying too much mounting space of the display module 210, the battery module 250 and other modules, and also avoid the camera module 220 from occupying the mounting space of a detachable structure in the connecting portion 111 of wristband 600. Accordingly, the mounting area of the display module 210 can be ensured to be large, so that the user can perform better human-computer interaction, and the mounting area of modules such as the battery module 250 also can be enlarged, thereby improving the battery life of the wrist-worn apparatus. Of course, in other embodiments, the outer side surface of the mounting portion 125 may be disposed flush with the outer peripheral surface of the middle bezel 100.

In an embodiment, the pressure relief hole 124 is located on a side of the mounting portion 125 facing the rear surface of the wrist-worn apparatus, that is, the accommodating groove 123 and the mounting portion 125 are distributed in the thickness direction of the wrist-worn apparatus, so that the space of the middle bezel 100 in the thickness direction of the wrist-worn apparatus can be fully utilized, thereby further improving the structural compactness of the wrist-worn apparatus.

In an embodiment, the mounting portion 125 is provided with a first mounting groove 126, the first mounting groove 126 extends toward an inner side of the second bezel wall 120 and penetrates through an inner side surface of the second bezel wall 120, and the camera module 220 is provided in the first mounting groove 126. Specifically, the first mounting groove 126 is located on a side where the display module 210 is located, a cover plate of the display module 210 covers the first mounting groove 126 so as to enclose the camera module 220 therein, in this way, an additional outer cover may be not be provided to enclose the camera module 220 therein when mounting the camera module 220, which is beneficial to reduce the assembling process, facilitates sealing of the display module 210 and the camera module 220, and improves the waterproof effect of the wrist-worn apparatus. Of course, in other embodiments, the camera module 220 may also be disposed on a surface of the mounting portion 125, for example, the mounting portion 125 is adjacent to the rear surface of the wrist-worn apparatus, and is spaced apart from a surface where the display module 210 is located.

In an embodiment, the mounting portion 125 is provided on the second bezel wall 120 on a three o'clock orientation side of the middle bezel 100. Specifically, the second bezel wall 120 on the three o'clock orientation side of the middle bezel 100 is the second bezel wall 120 between a twelve o'clock position and a six o'clock position in a clockwise direction, that is, the mounting portion 125 may be disposed at a two o'clock position, three o'clock position or four o'clock position, etc. Generally, the user wears the watch on a left wrist, and by providing the mounting portion 125 on the second bezel wall 120 on the three o'clock orientation side of the middle bezel 100, the camera module 220 can be provided away from the cuff of the user's clothing, which can avoid a situation where the cuff of the user's clothing blocks the camera module 220. Of course, in other embodiments, the mounting portion 125 is provided on the second bezel wall 120 on a nine o'clock orientation side of the middle bezel 100.

Referring to FIGS. 1-3, in an embodiment, an operation key 270 is provided on an outer side surface of the second bezel wall 120 where the mounting portion 125 is located, and the operation key 270 is disposed adjacent to the mounting portion 125. Specifically, the operation key 270 may be a button or a watch crown, and in order to facilitate user operation, the operation key 270 is usually protruded on the outer side surface of the second bezel wall 120. After the mounting portion 125 is arranged, the mounting portion 125 also protrudes from the outer peripheral surface of the second bezel wall 120. Arranging the operation key 270 adjacent to the mounting portion 125 is equivalent to arranging the operation key 270 on the side of the mounting portion 125. Compared with the manner of arranging the operation key 270 on the second bezel wall 120 of the middle bezel 100 that is opposite to the mounting portion 125, arranging the operation key 270 by utilizing a corner space between the protruding mounting portion 125 and the outer peripheral surface of the second bezel wall 120 is beneficial to improving the structural compactness of the wrist-worn apparatus. Of course, in other embodiments, the operation key 270 may also be provided on the second bezel wall 120 of the middle bezel 100 that is opposite to the mounting portion 125.

In an embodiment, the number of the operation key 270 is two, and the two operation keys 270 are disposed on two opposite sides of the mounting portion 125 respectively. When two operation keys 270 are arranged, the operability of the wrist-worn apparatus can be improved and thereby facilitating human-computer interaction for users. By arranging two operation keys 270 on opposite sides of the mounting portion 125, which is equivalent to arranging one operation key 270 in each of the corner spaces between the two opposite sides of the protruding mounting portion 125 and the outer side surface of the second bezel wall 120, the corner space between the mounting portion 125 and the outer peripheral surface of the second bezel wall 120 can be fully utilized, further improving the structural compactness of the wrist-worn apparatus. Of course, in other embodiments, the operation keys 270 may also be provided on only one side of the mounting portion 125.

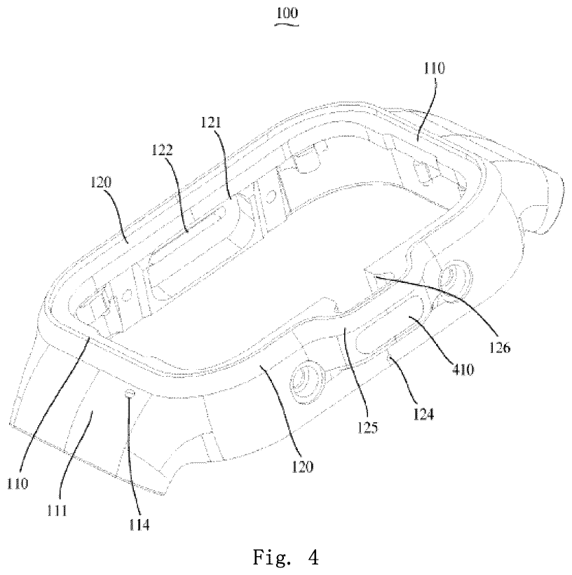

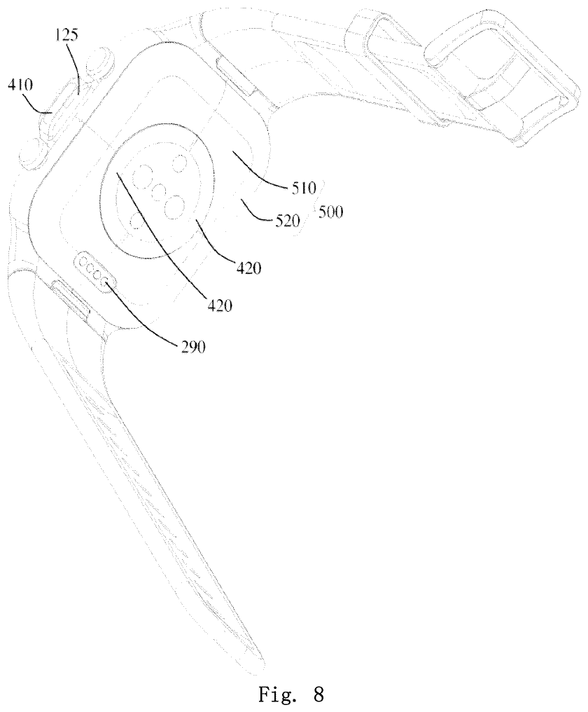

Referring to FIGS. 4 and 8, in an embodiment, the plurality of the functional modules include a physiological signal detection module, the physiological signal detection module is provided with a finger pressure detection electrode 410, and the finger pressure detection electrode 410 is disposed on the mounting portion 125. The physiological signal detection module is used to detect the user's physiological signals, such as heart rate signals or ECG signals. The finger pressure detection electrode 410 is used to be pressed by the user's fingers that are not wearing the wrist-worn apparatus. Specifically, the physiological signal detection module may be an ECG module (ECG: Electrocardiogramar a PPG module (PPG: Photoplethysmography, light volume change mapping method); or, the wrist-worn apparatus includes an ECG module and a PPG module, at least one of them is provided with a finger pressure detection electrode 410. By arranging the finger pressure detection electrode 410 on the mounting portion 125, the space of the mounting portion 125 can be fully utilized, and the structural compactness of the wrist-worn apparatus can be further improved. In addition, in some current wrist-worn apparatus, the finger pressure detection electrode 410 is disposed on the watch crown/button; however, since the watch crown/button is connected to the internal structure of the watch body through movable parts, a reliable transfer structure needs to be added, this will not only increase the structural complexity of the wrist-worn apparatus, but also increase the risk of contact disconnection. By arranging the finger pressure detection electrode 410 on the mounting portion 125, the mounting portion 125 being always fixed relative to the middle bezel 100 (second bezel wall 120), so that the defects generated when the finger pressure detection electrode 410 is arranged on the watch crown/button can be avoided, thereby being beneficial to improve the reliability of the psychological detection module and simplifying the structure of the wristband device. Of course, in other embodiments, the finger pressure detection electrode 410 may also be disposed at other positions on the second bezel wall 120.

Here, there are many methods to arrange the finger pressure detection electrode 410. For example, in an embodiment, the mounting portion 125 is made of conductive material, and the mounting portion 125 is electrically connected to the physiological signal detection module so that the mounting portion 125 serves as the finger pressure detection electrode 410, and a press detection area is provided on a surface of the mounting portion 125 away from the display module 210. Specifically, the press detection area is used to be pressed by the user's fingers, in this way, the mounting portion 125 is used as the finger pressure detection electrode 410, which can avoid installing an additional electrode structure on the mounting portion 125, simplify the structure of the mounting portion 125, and reduce assembling process of the wrist-worn apparatus. In an embodiment, the middle bezel 100 is made of conductive material as a whole, and when an insulating layer is provided on the outer surface of the middle bezel 100, the insulating layer is located outside the press detection area, that is, no insulating layer is provided in the press detection area to ensure normal conductivity when the press detection area comes into contact with the user's fingers. In order to easily distinguish the press detection area, a conductive touch contour may be laser-engraved on the periphery of the press detection area. The material of the mounting portion 125 may be metal or other conductive non-metal.

In another embodiment, the mounting portion 125 is made of insulating material, and the finger pressure detection electrode 410 is embedded in the mounting portion 125 and exposed on a surface of the mounting portion 125 away from the display module 210. Specifically, the finger pressure detection electrode 410 and the mounting portion 125 may be integrally injection molded, or a mounting hole may be formed on the mounting portion 125 and the finger pressure detection electrode 410 may be mounted in the mounting hole. Accordingly, it is possible to ensure the independence of the finger pressure detection electrode 410 and thereby being beneficial to increase the reliability of the physiological signal detection module.

In an embodiment, the wrist-worn apparatus further includes a back cover 500 connected to the middle bezel 100, the physiological signal detection module is further provided with at least one wearing detection electrode 420, the wearing detection electrode 420 is disposed on the back cover 500. With this arrangement, when the user wears the wrist-worn apparatus, the wearing detection electrode 420 can be brought into contact with an arm of the user on which the wrist-worn apparatus is worn, so that the wearer's physiological signals can be detected in real time by the wearing detection electrode 420. Moreover, when used in combination with the finger pressure detection electrode 410, the physiological parameters of two arms of the user can be detected, which can improve the detection accuracy of the physiological signal detection module. Wherein, the middle bezel 100 and the back cover 500 may be integrally formed, or may be formed separately and assembled together.

In an embodiment, the physiological signal detection module is provided with at least two wearing detection electrodes 420, each of the wearing detection electrodes 420 is provided on the back cover 500, and the wearing detection electrodes 420 are spaced apart from each other. Accordingly, the number of wearing detection electrodes 420 is increased and the detected parameter values are increased, so that the detection results obtained by the physiological signal detection module based on multi-parameter analysis are more accurate, which can improve the detection accuracy of the physiological signal detection module.

Referring to FIG. 3, in an embodiment, the middle bezel 100 is made of conductive material, the wrist-worn apparatus further includes a circuit board 260 provided in the middle bezel 100 and a mobile communication module provided on the circuit board 260. The mobile communication module is provided with a feed terminal 310 and a ground terminal 320, both of the feed terminal 310 and the ground terminal 320 are located on a side of the circuit board 260 away from the camera module 220, and are electrically connected to the middle bezel 100 so that the middle bezel 100 serves as an antenna carrier of the mobile communication module. Specifically, the mobile communication module may be a G module (for example a GSM module), a G module (for example a TD-CDMA module or WCDMA module), a G module (for example an LTE module, LTE: Long Term Evolution), a G module or other network standard modules. In this way, the middle bezel 100 is used as the antenna carrier of the mobile communication module, and additional antenna carrier structures can be avoided, thereby reducing the number of components and making the structure of the wrist-worn apparatus more compact, in addition, the molding and assembly processes can also be reduced, which is beneficial to reduce the costs. Of course, in other embodiments, an additional antenna structure may also be provided on the middle bezel 100.

In an embodiment, the feed terminal 310 and the ground terminal 320 are both electrically connected to the second bezel wall 120 where the loudspeaker module 230 is located, and the feed terminal 310 and the ground terminal 320 are separately provided on two opposite sides of the loudspeaker module 230. In this way, the space on the two opposite sides of the loudspeaker module 230 may be used to arrange the feed terminal 310 and the ground terminal 320. For example, when the operation key 270 and the camera module 220 are arranged on one of the second bezel walls 120, the other of the second bezel walls 120 does not need be provided with an operation key 270 so that there is enough space for arranging the feed terminal 310 and the ground terminal 320, which is beneficial to make the overall layout of the wrist-worn apparatus compact. Of course, in other embodiments, both of the feed terminal 310 and the ground terminal 320 may be electrically connected to the first bezel wall 110, or one of the feed terminal 310 and the ground terminal 320 is electrically connected to the first bezel wall 110, and the other of the feed terminal 310 and the ground terminal 320 is electrically connected to the second bezel wall 120.

In an embodiment, the ground terminal 320 is detachably connected to the middle bezel 100 and elastically abuts the circuit board 260. Specifically, the ground terminal 320 has an elastic sheet structure, and the ground terminal elastically abuts a corresponding circuit contact area on the circuit board 260 to achieve electrical connection between the circuit board 260 and the ground terminal 320. By detachably connecting the ground terminal 320 to the middle bezel 100, the ground terminal 320 can be easily replaced, so that the antenna parameters of the mobile communication module can be adjusted by replacing different ground terminals 320, to ensure that the mobile communication module reaches a better state and improve the communication quality. When the ground terminal 320 elastically abuts the circuit board 260, the process of fixing the ground terminal 320 to the circuit board 260 can be reduced, thereby facilitating the replacement of the ground terminal 320. Of course, in other embodiments, the ground terminal 320 may also be detachably connected with the circuit board 260.

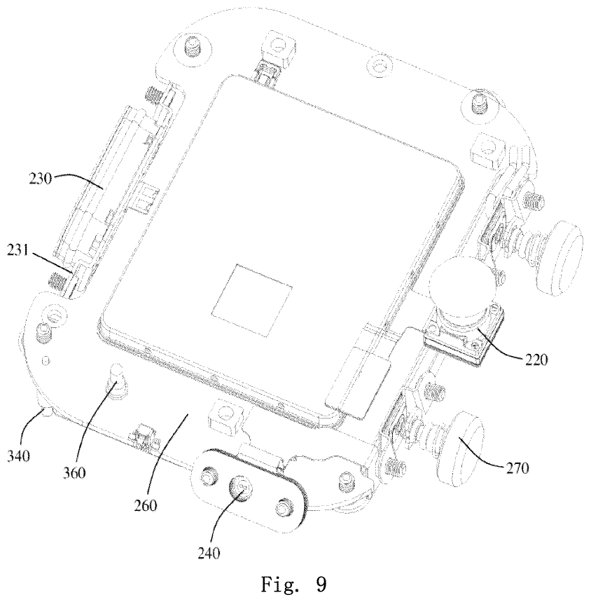

Referring to FIGS. 3 and 9, in an embodiment, the wrist-worn apparatus further includes a loudspeaker fixing member 231. The loudspeaker fixing member 231 is connected to the middle bezel 100 through a screw and is located on a side of the loudspeaker module 230 away from the sound outlet hole 122, to fix the loudspeaker module 230 on the middle bezel 100, the ground terminal is fixed on the loudspeaker fixing member 231 through a screw. That is, the ground terminal 320 and the loudspeaker fixing member 231 are fixed on the middle bezel 100 by the screws, and by using the fixing structure of the loudspeaker module 230 to fix the ground terminal 320 in this way, an additional connection structure for fixing the ground terminal 320 can be avoided, thereby simplifying the structure of the wrist-worn apparatus.

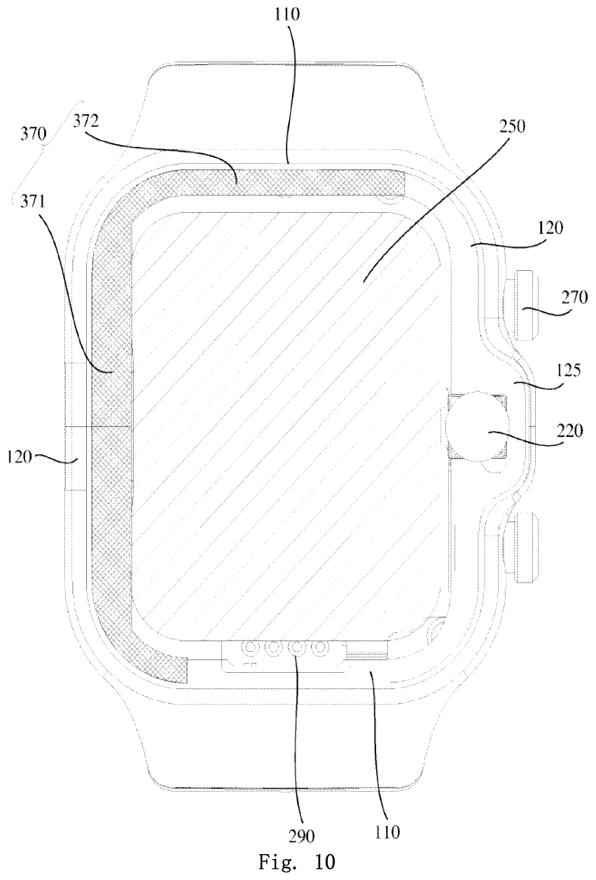

Referring to FIG. 10, in an embodiment, the wrist-worn apparatus includes a battery module 250, an antenna clearance area 370 is provided between the inner side of the second bezel wall 120 where the loudspeaker module 230 is located and the battery module 250, and at least one end portion of the antenna clearance area 370 extends to between the inner side of the first bezel wall 110 and the battery module 250. Specifically, the battery module 250 is electrically connected to the circuit board 260, and the antenna clearance area 370 is disposed such that both ends penetrate through in a thickness direction of the wrist-worn apparatus, thus the antenna clearance area 370 is disposed by making full use of a space between the second bezel wall 120 where the loudspeaker module 230 is located and the battery module 250 and by using a space between the inner side of the first bezel wall 110 and the battery module 250, thereby it can enhance the structural compactness of the wrist-worn apparatus while reducing an interference received by the mobile module communication module when the mobile communication transmits and receives signals and improving communication quality. Moreover, when the operation key 270 and the camera module 220 are arranged on one of the second bezel walls 120, the other of the second bezel walls 120 does not need to be provided with an operation key 270, so that there is enough space for arranging the antenna clearance area 370, and it also can avoid the situation where the operation key 270 extends into the antenna clearance area 370 and affects the communication quality.

In an embodiment, the wrist-worn apparatus further includes a charging module 290 electrically connected to the battery module 250, the antenna clearance area 370 extending to between the inner side of the first bezel wall 110 and the battery module 250 and the charging module 290 are disposed on two opposite sides of the battery module 250 respectively. Specifically, the antenna clearance area 370 includes a first clearance area 371 located between the inner side of the second bezel wall 120 where the loudspeaker module 230 is located and the battery module 250, and a second clearance area 372 extends from one end portion of the first clearance area 371 to between the inner side of the first bezel wall 110 and the battery module 250, that is, the second clearance area 372 and the charging module 290 are separately located on two opposite sides of the battery module 250. Accordingly, it is equivalent to that, the charging module 290 is disposed on the inner side of one of the first bezel walls 110, the antenna clearance area 370 is disposed between the other of the first bezel walls 110 and the battery module 250, which can avoid interference between the charging module 290 and the antenna clearance area 370 (the second clearance area 372) and make the internal structural layout of the wrist-worn apparatus more compact.

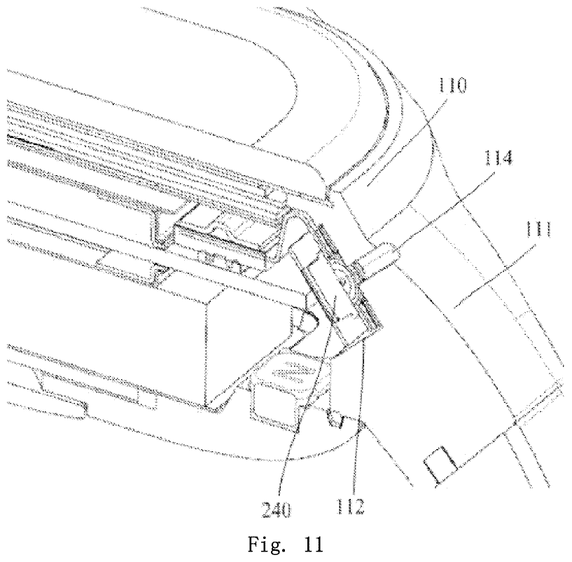

Referring to FIGS. 4, 9 and 11, in an embodiment, a second mounting groove 112 is provided on the inner side surface of the first bezel wall 110, the connecting portion 111 of wristband 600 is provided with a sound inlet hole 114 of the microphone, and the sound inlet hole 114 is communicated with the second mounting groove 112; one of the functional modules is a microphone module 240 (i.e. a microphone), the microphone module 240 is disposed in the second mounting groove 112, and a sound receiving end portion of the microphone module 240 is disposed to face the sound inlet hole 114. The microphone module 240 is electrically connected to the circuit board 260 for performing audio input. It will be understood that the sound inlet hole 114 is used to collect sound for the microphone module 240. By providing the second mounting groove 112 on the inner side of the first bezel wall 110 and then providing the microphone module 240 in the second mounting groove 112, it is equivalent to movement of the microphone module 240 outward, in this way, it can avoid a situation where the microphone module 240 protrudes too much from the inner circumference of the middle bezel 100 and occupies the mounting space of the battery module 250 or other modules. Also, it can reduce the space occupied by the microphone module 240 in the middle bezel 100, so that the space available for mounting the modules such as the battery module 250 in the middle bezel 100 is large, which is facilitate to improve the battery life of the wrist-worn apparatus. In the embodiment, the sound inlet hole 114 is provided at an end portion of the first bezel wall 110 away from the loudspeaker module 230 so that the sound inlet hole 114 is distanced apart from the sound outlet hole 122, and the possibility that the sound waves radiated outward from the sound outlet hole 122 and the sound inlet hole 114 interfere with each other is reduced. In an embodiment, the microphone module 240 is disposed on the second bezel wall 120 at the six o'clock orientation side of the middle bezel 100 (the connecting portion 111 of wristband 600).

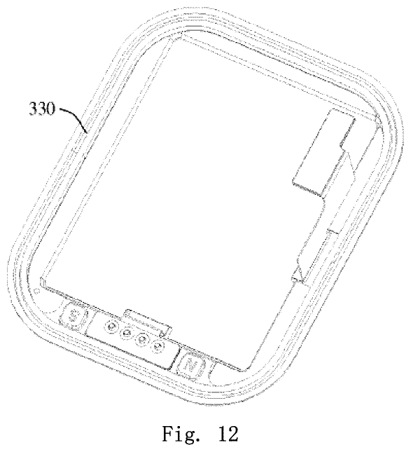

Referring to FIGS. 5, 6 and 12, in an embodiment, the wrist-worn apparatus further includes a back cover 500 and a WI-FI module, the back cover 500 is connected to the middle bezel 100, the WI-FI module is provided with a first antenna 330, and the first antenna 330 is disposed on an inner surface of the back cover 500. Specifically, the Wi-Fi module is electrically connected to the circuit board 260, and the back cover 500 may be made of ceramic, plastic or other non-metallic materials. By disposing the first antenna 330 on the inner surface of the back cover 500, the first antenna 330 can transmit and receive signals through the back cover 500, thus it can reduce interferences on the WI-FI module by the middle bezel 100 and other components, and improve signal transmission efficiency and signal quality. Of course, in other embodiments, a Bluetooth module or a radio frequency module may also be provided.

In an embodiment, the WI-FI module further includes a first feed switch 340 provided on the circuit board 260. The first feed switch 340 is provided between the second bezel wall 120 where the loudspeaker module 230 is located and the charging module 290, and is electrically connected with the first antenna 330. That is, the first feed switch 340 is disposed at an inner side of a connection between the first bezel wall 110 on the six o'clock orientation side of the middle bezel 100 and the second bezel wall 120 on the nine o'clock orientation side of the middle bezel 100. Compared to disposing the first feed switch 340 in the antenna clearance area 370 between the first bezel wall 110 and the battery module 250, in the embodiment, an impact of the first feed switch 340 on the antenna clearance area 370 can be reduced and good signal quality of the mobile communication module can be ensured.

In an embodiment, the battery module 250 of the wrist-worn apparatus is disposed in the middle bezel 100 and is spaced apart from the inner side surface of the middle bezel 100, and the first antenna 330 is at least partially disposed between the inner side surface of the middle bezel 100 and the battery module 250. By disposing the first antenna 330 between the inner side surface of the middle bezel 100 and the battery module 250, the interference on the first antenna 330 by the middle bezel 100 and the battery module 250 can be further reduced, thereby improving the Wi-Fi module signal transmission efficiency and signal quality.

In an embodiment, the first antenna 330 has a ring shape and extends in a circumferential direction of the middle bezel 100. Such an arrangement allows the first antenna 330 to radiate outward when transmitting signals and allows the first antenna 330 to receive signals from all around, this increases an area of the first antenna 330, and thus it is beneficial to further improve the Wi-Fi module signal transmission efficiency and signal quality. Of course, in other embodiments, the first antenna 330 may also be in a strip shape.

In an embodiment, the back cover 500 includes an annular connecting portion 510 and a cover plate portion 520 located inside the annular connecting portion 510, the annular connecting portion 510 is connected to the middle bezel 100, the cover plate portion 520 is configured to protrude towards a direction away from the display module 210 in comparison to the annular connecting portion 510, and the first antenna 310 is provided on an inner surface of the annular connecting portion 510. Specifically, the annular connecting portion 510 corresponds to a gap between the inner side surface of the middle bezel 100 and the battery module 250, that is, an orthographic projection on the back cover 500 by the gap between the inner side surface of the middle bezel 100 and the battery module 250 is located at the annular connecting portion 510. By configuring the cover plate portion 520 to protrude towards a direction away from the display module 210 in comparison to the annular connecting portion 510, the cover plate portion 520 comes into contact with the use's arm when the user wears the wrist-worn apparatus, so that the annular connecting portion 510 is space apart from the use's arm, which ensures that the Wi-Fi module signal can be better transmitted and received between the annular connecting portion 510 and the use's arm, and thereby reducing the interference of the arm on wireless signal transmission, and improving the Wi-Fi module signal transmission efficiency and signal quality. Of course, in other embodiments, the back cover 500 may also be arranged in a flat plate shape.

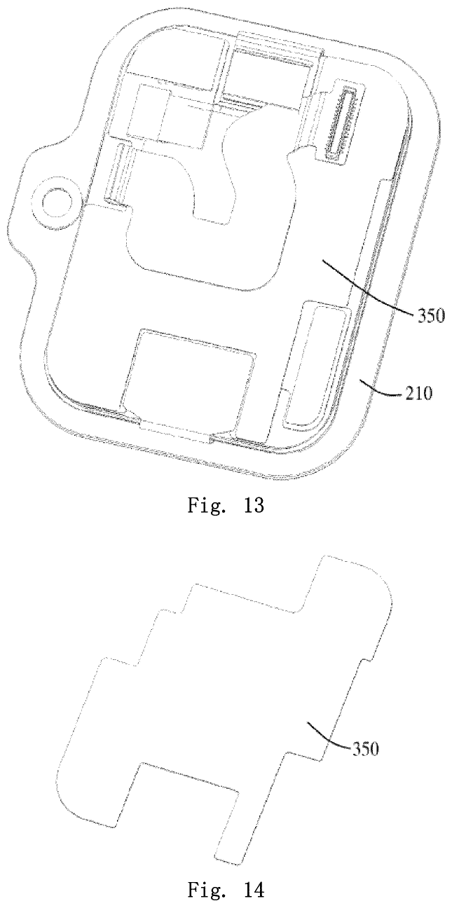

Referring to FIGS. 13-14, in an embodiment, the wrist-worn apparatus further includes a positioning module, the positioning module is provided with a second antenna 350, and the second antenna 350 is provided on the rear surface of the display module 210. With this arrangement, positioning signals may be radiated upward by the display module 210 to avoid electromagnetic interference from the middle bezel 100, thereby improving the positioning signal transmission efficiency and quality.

In an embodiment, the second antenna 350 has a sheet shape and is laid on the rear surface of the display module 210. With this arrangement, an area of the second antenna 350 may be larger, and a thickness of the second antenna 350 may be thinner while increasing the area of the antenna for transmitting and receiving signals, so that a space occupied by the second antenna 350 in the thickness direction of the wrist-worn apparatus is reduced, which is beneficial to reduce the thickness of wrist-worn apparatus. Of course, in other embodiments, the second antenna 350 may also be in a strip shape.

Referring to FIGS. 3, 9 and 13, in an embodiment, the positioning module further includes a second feed switch 360 provided on the circuit board 260. The second feed switch 360 is disposed between the second bezel wall 120 where the loudspeaker module 230 is located and the charging module 290, and is electrically connected with the second antenna 350. That is, the second feed switch 360 is disposed at an inner side of a connection between the first bezel wall 110 on the six o'clock orientation side of the middle bezel 100 and the second bezel wall 120 on the nine o'clock orientation side of the middle bezel 100. Compared to disposing the second feed switch 360 in the antenna clearance area 370 between the first bezel wall 110 and the battery module 250, in the embodiment, an impact of the second feed switch 360 on the antenna clearance area 370 can be reduced and good signal quality of the positioning module can be ensured.

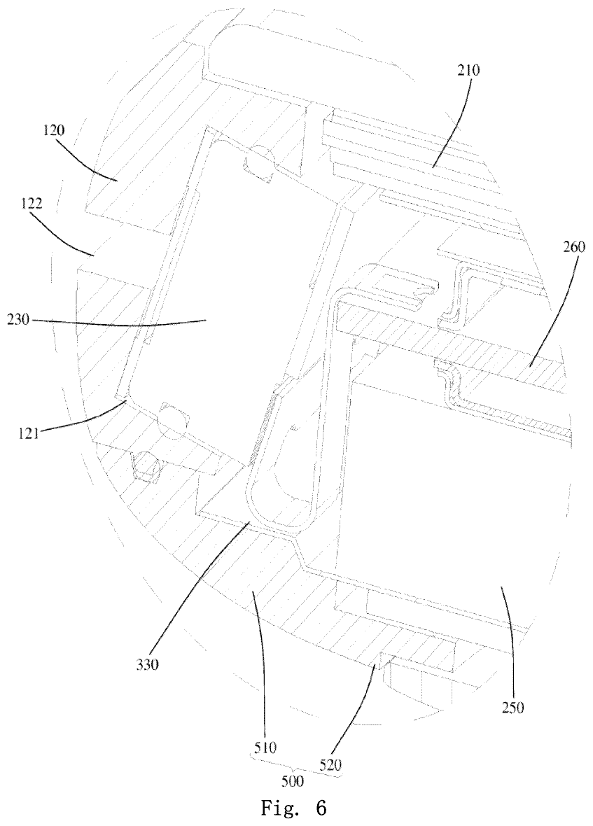

Referring to FIG. 6, in an embodiment, the wrist-worn apparatus includes a circuit board 260 and a battery module 250 electrically connected to the circuit board 260. The circuit board 260 is disposed between the display module 210 and the battery module 250; a surface of the circuit board 260 facing the battery module 250 and a surface of the circuit board 260 facing the display module are both electronic device mounting surfaces. That is, electronic devices are attached on both front and back sides of the circuit board 260, effectively ensuring the placement area and enabling dual-system circuit layout design.

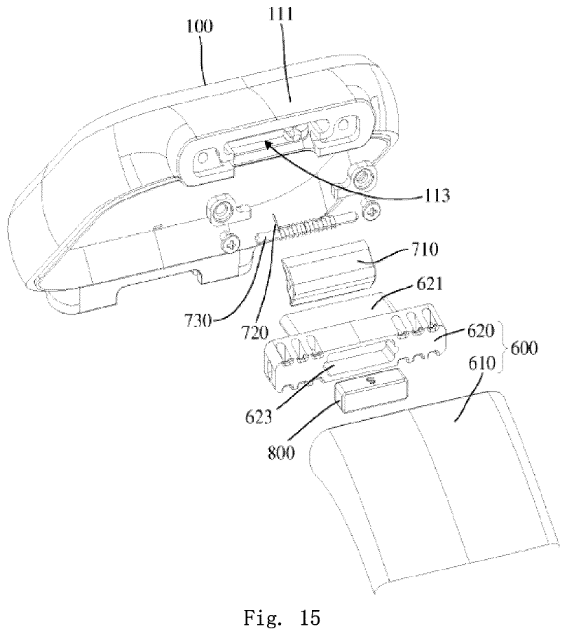

Referring to FIGS. 15-17, in an embodiment, the wrist-worn apparatus further includes a wristband 600 and a connecting member 710, the connecting portion 111 of wristband 600 of the middle bezel 100 is provided with a third mounting groove 113, and the connecting member 710 has a buckle portion 711 disposed inside the third mounting groove 113 and a driving portion 712 exposed outside the third mounting groove 113, the connecting member 710 is movably pivoted to the third mounting groove 113, so that the buckle portion 711 has a first position and a second position, and driving the driving portion 712 enables the buckle portion 711 to move between the first position and the second position; an end portion of the wristband 600 is provided with a plug-in portion 621, and the plug-in portion 621 is detachably connected to the third mounting groove 113 and is provided with a slot 622 which is fitted with the buckle portion 711; at the first position, the buckle portion 711 is engaged with the slot 622 to lock the wristband 600; at the second position, the buckle portion 711 is disengaged from the slot 622 to unlock the wristband 600.

It will be understood that when the buckle portion 711 is in the second position, the buckle portion 711 no longer interferes with the movement of the plug-in portion 621, the wristband 600 is unlocked, and can freely move into and out the third mounting groove 113. Without loss of generality, in the embodiment, when mounting the wristband 600, by acting on the driving portion 712 to drive the buckle portion 711 to move to the second position, and then inserting the plug-in portion 621 into the third mounting groove 113 until the plug-in portion 621 is inserted in place, then moving the buckle portion 711 to the first position so that the buckle portion 711 is locked into the slot 622, and at this time, the plug-in portion 621 is limited by the buckle portion 711 and cannot move in the third mounting groove 113 anymore, and in this way, the wristband 600 can be locked, and the mounting of the wristband 600 is completed very conveniently. Of course, in other embodiments, when mounting the wristband 600, the buckle portion 711 may not be in the second position, and instead, the plug-in portion 621 is inserted into the third mounting groove 113 to push against the buckle portion 711, so as to drive the buckle portion 711 to move towards the first position, and when the buckle portion 711 moves to the first position, the plug-in portion 621 is inserted into place, and the buckle portion 711 can also be engaged in the slot 622 to lock the wristband 600, in this way, the wristband 600 may also be easily mounted. The wristband 600 may adopt a conventional watchband structure, which is not limited herein.

When disassembling the wristband 600, force is required to be applied only on the driving portion 712 to drive the buckle portion 711 to move from the first position to the second position, and thereby the wristband 600 can be pulled out of the third mounting groove 113.

Taking the wrist-worn apparatus is a watch as an example. In existing watches, the wristband 600 is fixed on the dial through fasteners such as spring bars, and a fixing groove of wristband 600 is processed on a watch case, and during assembling, the spring bars need to be inserted into spring bar holes of the wristband 600 provided at the top portion of the wristband 600, both ends of the spring bar are aligned with the fixing groove of wristband 600, and a bar of the spring bar is moved, so that spring bar studs at both ends are completely inserted into the fixing groove of wristband 600; similarly, during disassembling, the bar of the spring bar is moved, so that the spring bar stud at one side is disengaged from the fixing groove of wristband 600 and then the whole wristband 600 is removed. However, due to small size of the spring bar, it is difficult to align the spring bar stud and slide the bar during the process of assembling and disassembling the wristband 600, causing inconvenience in replacing the wristband 600. In addition, when disassembling and assembling the wristband 600, it additionally needs to disassembly and assembly the spring bars, resulting in a very cumbersome process.

The detachable connection between the watch strap (wristband 600) and the dial (middle bezel 100) is completed by using the connecting member 710 to replace conventional spring bars. When disassembling and assembling the wristband 600, the user applies force on the driving portion 712 to drive the buckle portion 711 to move, and the size of the driving portion 712 is much larger than that of the spring bars, thus it is very convenient to operate. In addition, during the processes of disassembling and assembling the wristband 600, the connecting member 710 is always provided in the third mounting groove 113, so that it only needs to insert the plug-in portion 621 into the third mounting groove 113 or pulling out the plug-in portion 621 from the third mounting groove 113, which greatly improves the convenience of disassembling and assembling the wristband 600.

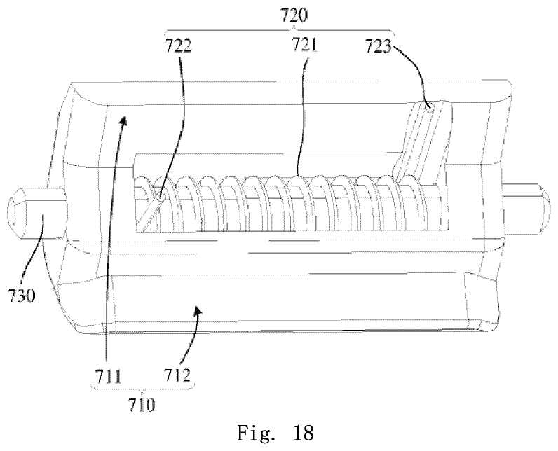

Further, referring to FIGS. 15, 16 and 18, in the embodiment, the wrist-worn apparatus further includes an elastic member 720. When the buckle portion 711 is at the second position, the elastic member 720 is in an elastic deformation state, and the connecting member 710 is subjected to a reverse elastic force by the elastic member 720, so that the buckle portion 711 has a tendency of returning to the first position. Accordingly, when no external force is input, the force is applied to the plug-in portion 621 by the elastic member 720 and the buckle portion 711 can be stably in the first position to ensure that the wristband 600 is locked. After the wristband 600 is disassembled, the external force exerted on the driving portion 712 is removed, the connecting member 710 is subject to a reverse elastic force by the elastic member 720, and the buckle portion 711 will be reset to the first position, the connecting member 710 after reset does not move relative to the third mounting groove 113 anymore, which can avoid unnecessary abrasion of the connecting member 710. Further, such an arrangement can also improve the convenience of installing the wristband 600. When installing the wristband 600, force is applied to the driving portion 712 to move the buckle portion 711 to the second position, and then when it is confirmed that the plug-in portion 621 is inserted in place, the external force exerted on the driving portion 712 can be removed, the buckle portion 711 can be reset to the first position under the action of elastic force, automatically completing the locking of the wristband 600, which greatly improves the convenience of installing the wristband 600. Of course, in other embodiments, when the buckle portion 711 is in the first position, the driving portion 712 is engaged with the third mounting groove 113, and in this way, the connecting member 710 can be fixed to the middle bezel 100 and the buckle portion 711 can be stably disposed in the slot 622 to ensure that the wristband 600 is locked; when disassembling the wristband 600, the wristband 600 can be unlocked by releasing the buckle connection between the driving portion 712 and the third mounting groove 113 and driving the buckle portion 711 to move to the second position.

Furthermore, in the embodiment, the elastic member 720 is a torsional spring provided on a connecting shaft 730; the torsional spring includes a spring body 721 sleeved outside the connecting shaft 730 and a first torsion arm 722 and a second torsion arm 723 connected to both ends of the spring body 721, the first torsion arm 722 is connected to the connecting member 710, and the second torsion arm 723 is connected to the third mounting groove 113; when the buckle portion 711 is in the second position, the first torsion arm 722 elastically abuts against the third mounting groove 113, the second torsion arm 723 elastically abuts against the connecting member 710, so that the spring body 721 is in an elastic deformation state to allow the buckle portion 711 to have a tendency of returning to the first position.

In the embodiment, the torsional spring is used as the elastic member 720, the spring body 721 of the torsional spring is sleeved on the connecting shaft 730, and thus it is very convenient for installation. When the buckle is in the second position, the spring body 721 is in elastic deformation, and since the second torsion arm 723 is connected to the third mounting groove 113, the second torsion arm 723 and a groove wall of the third mounting groove 113 can be maintained relatively unchanged. Accordingly, under the action of elastic force, the torsional spring acts on the connecting member 710 through the first torsion arm 722 to move the connecting member 710, so that the buckle portion 711 has a tendency of returning to the first position. Of course, in other embodiments, the elastic member 720 may also be provided as a spring or an elastic piece.

Furthermore, in the embodiment, the wrist-worn apparatus further includes the connecting shaft 730, the connecting shaft 730 is installed in the third mounting groove 113, and the connecting member 710 is pivotally connected to the third mounting groove 113 through the connecting shaft 730. Optionally, the number of the connecting shaft 730 may be one or two. It will be understood that when it is provided with one connecting shaft 730, the connecting shaft 730 should pass through the connecting member 710, and both ends of the connecting shaft 730 should be exposed outside the connecting member 710, so that the both ends of the connecting shaft 730 can be connected with two opposite groove walls of the third mounting groove 113, thereby the connecting member 710 is pivotally connected to the third mounting groove 113; when it is provided with two connecting shafts 730, the two connecting shafts 730 are separately arranged on both sides of the connecting member 710, and both ends of the connecting shaft 730 are respectively connected to the groove wall of the third mounting groove 113 and the outer wall of the connecting member 710. In this manner, the connecting member 710 can also be pivotally connected to the third mounting groove 113. In the embodiment, the connecting member 710 is pivotally connected to the third mounting groove 113 through the connecting shaft 730, which can improve the rotation stability of the connecting member 710 and the connection stability between the connecting member 710 and the middle bezel 100. Of course, in other embodiments, both ends of the connecting member 710 may also be provided with shaft projections, and the connecting member 710 is pivotally connected to the third mounting groove 113 through the shaft projections, and there is no need to provide an additional connecting shaft 730.

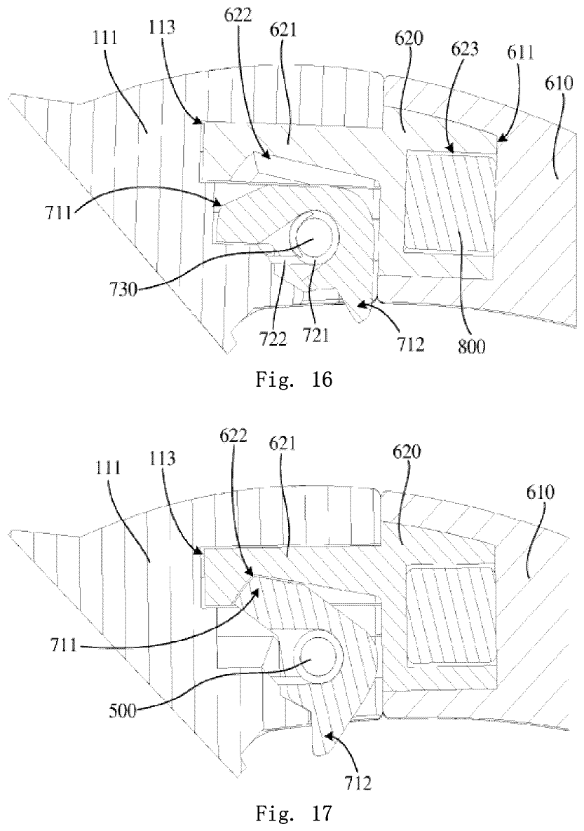

Referring to FIGS. 15-16, in an embodiment, the wrist-worn apparatus includes a wristband 600, a magnetic field sensor and a controller. The wristband 600 is detachably connected to the connecting portion 111 of wristband 600, the wristband 600 is provided with a magnet 800, and the magnetic field sensor is disposed in the middle bezel 100. The magnetic field sensor is used to sense magnetic field parameters of the magnet 800 and generate a corresponding screen display control signal. The controller is disposed in the middle bezel 100, and the controller can control the display module 210 to display a corresponding display mode according to the screen display control signal.

It will be understood that when users wear a wrist-worn apparatus, they often need to consider the matching of the wrist-worn apparatus and clothing, and often need to replace different styles of wristbands 600 according to different dressing styles. However, in the prior art, the wrist-worn apparatus remains unchanged, and it is difficult to match such a wrist-worn apparatus with different styles of wristbands 600, which greatly affects the user experience.

In the present disclosure, the wristband 600 is provided with the magnet 800, and the middle bezel 100 is provided with the magnetic field sensor, and the magnetic field sensor identifies the wristband 600 by sensing the magnetic field of the magnet 800. Different styles of wristbands 600 have different magnetic fields, and the magnetic field sensor can generate a corresponding screen display control signal according to the detected magnetic field, and transmit the screen display control signal to the controller, the controller receives the screen display control signal and controls a display portion to switch to different display modes based on this screen display control signal. Whereby, in the wrist-worn apparatus of the present disclosure, the display mode of the display portion is generated according to the screen display control signal, and the screen display control signal corresponds to the magnetic field of the magnet 800, and the magnet 800 corresponds to the wristband 600, thus the display mode of the wrist-worn apparatus matches with the wristband 600 so that the overall style of the wrist-worn apparatus is consistent, which facilitates the user's dressing collocation and thereby improving the user experience.

Furthermore, in this embodiment, the wrist-worn apparatus is provided with a plurality of sets of wristbands 600, and the magnets 800 of at least two sets of wristbands 600 have different magnetic field directions or different magnetic field strengths; the magnetic field sensor is used to sense the magnetic field direction or magnetic field strength, and generate different screen display control signals according to different magnetic field directions or magnetic field strengths; the controller can control the display portion to switch to different display modes according to different screen display control signals. In this embodiment, the magnetic field sensor detects one of the magnetic field direction and magnetic field strength of the magnet 800 to distinguish different styles of wristbands 600. It will be understood that among a plurality of sets of wristbands 600, for different sets of wristbands 600 with similar styles, the magnetic field direction or magnetic field strength of the magnet 800 can be set to be the same, and coordinates with the same display mode of the display portion, a harmonious effect can also be achieved; and in different sets of wristbands 600 with different styles, at least one of the magnetic field direction and magnetic field strength of the magnet 800 should be set to be different for sensing by the magnetic field sensor, so that the display portion can switch to different display modes correspondingly, thereby ensuring that the overall style of the wrist-worn apparatus can be consistent. Of course, in other embodiments, the magnetic field sensor may detect the magnetic field direction and magnetic field strength of the magnet 800 at the same time. In this case, in a series of wristbands 600 having a similar style (such as the same color series), the magnets 800 can be set to have the same magnetic field direction, and in different sets of wristbands 600 in the same series, the magnets 800 can be set to have different magnetic field strengths; corresponding to several series of wristbands 600, the display portion has several series of display modes, and each series of display modes further include a plurality of display modes with similar styles to correspond to different sets of wristbands 600 in the same series, so that the wristbands 600 match the display modes more harmoniously.

Furthermore, in the embodiment, different sets of wristbands 600 are provided with magnets 800 of the same shape, and the magnets 800 of at least two sets of wristbands 600 have different magnetization directions or magnetization amounts so that the magnetic field directions or magnetic field strengths are different. It should be noted that different sets of wristbands 600 are provided with magnets 800 of the same shape, which means that the magnets 800 with the same shape are installed at the same position of the wristbands 600 at the same installation angle. In this way, the magnets 800 may be connected to different sets of wristbands 600 in the same manner, which greatly facilitates the assembly of the magnets 800 with the wristbands 600. Without loss of generality, in the embodiment, the magnet 800 is provided in a square shape, and when the installation angle and installation position of the magnet 800 are determined, the magnet 800 has at most six magnetic field directions. When a wrist-worn apparatus is provided with no more than six sets of wristbands 600 having different styles, magnets 800 of the same shape can be magnetized in different magnetization directions, so that the magnetic field sensor can identify different styles of wristbands 600 by detecting the magnetic field directions. When a wrist-worn apparatus is provided with more than six sets of wristbands 600 having different styles, the magnetization amounts of the magnets 800 of the same shape can be controlled to obtain different magnetic field strengths for detection by the magnetic field sensor. Of course, in other embodiments, the magnet 800 may also be arranged in a ring shape, so that the magnetic field directions of the magnets 800 can be more diverse.

Furthermore, in the embodiment, the magnetic field sensor is a Hall sensor, and the screen display control signal is a Hall voltage. The Hall sensor can generate different Hall voltages according to different magnetic field directions of the magnet 800, and the controller controls the display portion according to the different Hall voltages, so that the display portion displays different display modes correspondingly. Of course, in other embodiments, the magnetic field sensor may be an electromagnetic sensor, and the screen display control signal may correspond to induced electromotive force.

Furthermore, in the embodiment, the different display modes have different UI (User Interface)) themes, and the controller is used to control the display portion to switch different UI themes. In the display modes with different UI themes, screen colors can be of different colors, icons can be of different shapes, and a plurality of icons can be arranged in different arrangements. In the embodiment, the display mode of the wrist-worn apparatus is switched to different UI themes according to different styles of wristbands 600, so that the style of the display mode can match the style of the wristband 600 and the overall style of the wrist-worn apparatus is more harmonious, thereby it is convenient for users to match different styles of clothing.

Of course, in other embodiments, different display modes may have different display contents. The display content may be one or more of user's heart rate, user's exercise path, blood oxygen, blood sugar, step counting, time, date, exercise mode, and sleep monitoring. The display content is not limited to the above examples. Considering that wrist-worn apparatus has many functions, if the display contents are all displayed on the display portion, it results in great inconvenience to users when obtaining information. Therefore, it is necessary to configure different display contents to the display portion (that is, user interface of the wrist-worn apparatus) according to different usage scenarios. Considering that users may change different styles of wristbands 600 according to different dressing styles in different usage scenarios, the wristband 600 and display content suitable for the same usage scenario can be associated in advance, so that the display portion can automatically configure display modes with different display contents for users according to different usage scenarios.

Referring to FIGS. 15-16, in an embodiment, the wristband 600 includes a wearing body 610 and a plug connector 620 provided on the wearing body 610. The plug connector 620 is provided with a plug-in portion 621, and a first groove 623 is provided on a surface of the plug connector 620 away from the plug-in portion 621, and the magnet 800 is provided in the first groove 623, and an end portion of the wearing body 610 is provided with a second groove 611. The portion of the plug connector 620 provided with the first groove 623 is installed in the second groove 611, and a notch of the first groove 623 is disposed to face a bottom wall of the second groove 611. In this way, at the time of installation, the magnet 800 can be installed in the first groove 623, then the portion of the plug connector 620 provided with the first groove 623 can be installed in the second groove 611, so that the magnet 800 is fixed in a receiving cavity enclosed by the first groove 623 and the second groove 611. in this way, it can not only effectively fix the magnet 800, but also increase a connection area between the plug connector 620 and the wearing body 610, and improve the connection stability between the plug connector 620 and the wearing body 610. Of course, in other embodiments, a fixing hole may also be provided on the side of the wristband 600, and the magnet 800 is inserted into the fixing hole.

The above are only preferred embodiments of the present disclosure, and do not limit the patent scope of the present disclosure. Under the inventive concept of the present disclosure, equivalent structural transformations made using the contents of the description and its accompanying drawings of the present disclosure, or direct/indirect applications in other related technical fields, are included in the protection scope of the present disclosure.

1. A wrist-worn apparatus, comprising:
a middle bezel;
a display module mounted to the middle bezel, a display area of the display module is located at an inner side of the middle bezel; and
a plurality of functional modules mounted on the middle bezel, and each of the functional modules is at least partially located on an outer peripheral side of the display area.

2. The wrist-worn apparatus of claim 1, wherein the middle bezel comprises two opposite first bezel walls and two opposite second bezel walls, the first bezel walls and the second bezel walls are alternately distributed in sequence in a circumferential direction of the middle bezel, and each of the two first bezel walls is provided with a wristband connecting portion, and
wherein the plurality of functional modules comprise a camera module and a loudspeaker module, the loudspeaker module is provided on one of the second bezel walls, and the camera module is provided on the other of the second bezel walls.

3. The wrist-worn apparatus of claim 2, wherein an accommodating groove is provided on an inner side surface of a second bezel wall where the camera module is located, a pressure relief hole is provided on a bottom wall of the accommodating groove, a venting waterproof component is provided in the accommodating groove, the venting waterproof component is configured to cover the pressure relief hole, and the pressure relief hole is communicated with a rear sound cavity of the loudspeaker module through the venting waterproof component, and/or
the second bezel wall is provided with a receiving groove and a sound outlet hole that penetrates through the receiving groove, the loudspeaker module is at least partially disposed in the receiving groove, and a sound outlet side of the loudspeaker module is configured to face the sound outlet hole.

4. The wrist-worn apparatus of claim 2, wherein the second bezel wall is provided with a mounting portion, the mounting portion is configured to protrude toward an outer peripheral surface of the second bezel wall, and the camera module is mounted to the mounting portion.

5. The wrist-worn apparatus of claim 4, wherein the mounting portion is provided with a first mounting groove, the first mounting groove extends toward an inner side of the second bezel wall and penetrates through an inner side surface of the second bezel wall, and the camera module is disposed in the first mounting groove, and/or
the mounting portion is provided on the second bezel wall on a three o'clock orientation side of the middle bezel, and/or
an operation key is provided on an outer side surface of a second bezel wall where the mounting portion is located, and the operation key is disposed adjacent to the mounting portion, there are two operation keys, and the two operation keys are disposed on two opposite sides of the mounting portion respectively.

6. The wrist-worn apparatus of claim 4, wherein the plurality of the functional modules further comprise a physiological signal detection module, the physiological signal detection module is provided with a finger pressure detection electrode, and the finger pressure detection electrode is disposed to the mounting portion.

7. The wrist-worn apparatus of claim 6, wherein the mounting portion is made of conductive material, the mounting portion is electrically connected to the physiological signal detection module, so that the mounting portion serves as the finger pressure detection electrode, and a press detection area is provided on a surface of the mounting portion away from the display module, or
the mounting portion is made of insulating material, and the finger pressure detection electrode is embedded in the mounting portion and exposed on the surface of the mounting portion away from the display module.

8. The wrist-worn apparatus of claim 6, wherein the wrist-worn apparatus further comprises a back cover connected to the middle bezel, and the physiological signal detection module is further provided with at least one wearing detection electrode, the wearing detection electrode is disposed on the back cover.

9. The wrist-worn apparatus of claim 2, wherein the middle bezel is made of conductive material, the wrist-worn apparatus further comprises a circuit board provided in the middle bezel and a mobile communication module provided on the circuit board, the mobile communication module is provided with a feed terminal and a ground terminal, and both of the feed terminal and the ground terminal are disposed on a side of the circuit board away from the camera module and are electrically connected to the middle bezel, so that the middle bezel serves as an antenna carrier of the mobile communication module.

10. The wrist-worn apparatus of claim 9, wherein both of the feed terminal and the ground terminal are electrically connected to a second bezel wall where the loudspeaker module is located, and the feed terminal and the ground terminal are disposed on two opposite sides of the loudspeaker module respectively; and/or
the ground terminal is detachably connected to the middle bezel, and elastically abuts the circuit board.

11. The wrist-worn apparatus of claim 9, wherein the wrist-worn apparatus comprises a battery module, an antenna clearance area is provided between an inner side of a second bezel wall where the loudspeaker module is located and the battery module, and at least one end portion of the antenna clearance area extends to between the inner side of the first bezel walls and the battery module.

12. The wrist-worn apparatus of claim 11, wherein the wrist-worn apparatus further comprises a charging module electrically connected to the battery module, the antenna clearance area extending to between the inner side of the first bezel wall and the battery module and the charging module are disposed on two opposite sides of the battery module respectively.

13. The wrist-worn apparatus of claim 2, wherein a second mounting groove is provided on an inner side of the first bezel wall, the wristband connecting portion is provided with a sound inlet hole, and the sound inlet hole is communicated with the second mounting groove; one of the plurality of functional modules is a microphone module, the microphone module is disposed in the second mounting groove, and a sound receiving end portion of the microphone module is disposed to face the sound inlet hole.

14. The wrist-worn apparatus of claim 1, wherein the wrist-worn apparatus further comprises a back cover and a WI-FI module, the back cover is connected to the middle bezel, the WI-FI module is provided with a first antenna, and the first antenna is provided on an inner surface of the back cover.

15. The wrist-worn apparatus of claim 14, wherein the battery module of the wrist-worn apparatus is disposed in the middle bezel and spaced apart from an inner side surface of the middle bezel, and the first antenna is at least partially disposed between the inner side surface of the middle bezel and the battery module, and/or
the first antenna has a ring shape and extends in a circumferential direction of the middle bezel, and/or
the back cover comprises an annular connecting portion and a cover plate portion located inside the annular connecting portion, the annular connecting portion is connected to the middle bezel, the cover plate portion is configured to protrude towards a direction away from the display module in comparison to the annular connecting portion, and the first antenna is provided on an inner surface of the annular connecting portion.

16. The wrist-worn apparatus of claim 1, wherein the wrist-worn apparatus further comprises a positioning module, the positioning module is provided with a second antenna, and the second antenna is disposed on a rear surface of the display module.

17. The wrist-worn apparatus of claim 16, wherein the second antenna has a sheet shape and is laid on the rear surface of the display module.

18. The wrist-worn apparatus of claim 1, wherein the wrist-worn apparatus comprises a circuit board and a battery module electrically connected to the circuit board, the circuit board is disposed between the display module and the battery module, and a surface of the circuit board facing the battery module and a surface of the circuit board facing the display module are both electronic device mounting surfaces.

19. The wrist-worn apparatus of claim 1, wherein the wrist-worn apparatus further comprises a wristband and a connecting member, the wristband connecting portion of the middle bezel is provided with a second mounting groove, the connecting member has a buckle portion disposed in the first mounting groove and a driving portion exposed to outside the first mounting groove, and the connecting member is movably pivoted to the first mounting groove, so that the buckle portion has a first position and a second position,
driving of the driving portion enables the buckle portion to move between the first position and the second position,
an end portion of the wristband is provided with a plug-in portion, and the plug-in portion is detachably connected to the second mounting groove and is provided with a slot engaged with the buckle portion,
at the first position, the buckle portion is engaged with the slot to lock the wristband, and
at the second position, the buckle portion is disengaged from the slot to unlock the wristband.

20. The wrist-worn apparatus of claim 1, wherein the wrist-worn apparatus comprises a wristband, a magnetic field sensor and a controller, the wristband is detachably connected to the wristband connecting portion, the wristband is provided with a magnet, the magnetic field sensor is disposed in the middle bezel, and the magnetic field sensor is used to sense magnetic field parameters of the magnet and generate a corresponding screen display control signal, the controller is disposed in the middle bezel, and the controller can control the display module to display a corresponding display mode according to the screen display control signal.
